(19) United States
(12) Patent Application Publication
(10) Pub. No.: US 2016/0078410 A1
(43) Pub. Date: Mar. 17, 2016

(54) Automated Meeting Negotiation With Dynamic Scheduling

(71) Applicant: TimeTrade Systems, Inc., Tewksbury, MA (US)

(72) Inventor: Tyler Horton, Tewksbury, MA (US)

(21) Appl. No.: 14/848,712

(22) Filed: Sep. 9, 2015

Related U.S. Application Data
(60) Provisional application No. 62/048,899, filed on Sep. 11, 2014.

(51) Int. Cl. G06Q 10/10

(52) U.S. Cl. CPC G06Q 10/1095

(57) ABSTRACT

A system that automatically arranges meetings for groups of one or more entities based on the collective availability of those entities, while also satisfying any constraints imposed on such a meeting by its organizer. Collective availability is computed from relevant scheduling data provided by attendees or the organizations to which they belong. The system relies on existing systems (when needed) to access all relevant schedules and availability data, as well as to amend the corresponding schedules when new meeting instances are created.

### PRIORITY CLAIM

This application claims priority to U.S. Provisional Application No. 62/048,899, filed Sep. 11, 2014, the entirety of which is incorporated herein by reference.

### TECHNICAL FIELD

The present invention relates generally to the field of time management software and calendaring software systems with particular consideration given to applications involving appointment scheduling and published availability.

### BACKGROUND

Current calendaring software systems only allow the organizer of such a meeting to choose from non-ideal approaches. One approach is to manually negotiate amongst all attendees and explicitly schedule a meeting every week. Another approach is to create a standard recurring meeting that will occasionally conflict with some attendees' schedules and which would still need to be manually rescheduled when resulting in too many conflicts.

### SUMMARY

Presented herein is a system that automatically arranges meetings for groups of one or more entities based on the collective availability of those entities, while also satisfying any constraints imposed on such a meeting by its organizer. Collective availability is computed from relevant scheduling data provided by attendees or the organizations to which they belong. The system relies on existing systems (when needed) to access all relevant schedules and availability data, as well as to amend the corresponding schedules when new meeting instances are created.

### BRIEF DESCRIPTION OF THE DRAWINGS

FIG. 1 is a sequence diagram depicting a general operational flow, according to an example embodiment.

FIG. 2 illustrates an example user interface to specify meeting criteria.

FIG. 3 illustrates an example of collective availability information for a first occurrence of a recurring meeting, according to an example embodiment.

FIG. 4 illustrates an example user interface to confirm system computation of collective availability, according to an example embodiment.

FIG. 5 illustrates an example of time slot selected for the first occurrence of the recurring meeting, according to an example embodiment.

FIG. 6 illustrates a sequence diagram illustrating operations performed during a monitoring phase for automated scheduling, according to an example embodiment.

FIG. 7 illustrates another example of a collective availability for a second occurrence of the recurring meeting, according to an example embodiment.

FIG. 8 illustrates an example of a time slot selected for the second occurrence of the recurring meeting, according to an example embodiment.

FIG. 9 illustrates an example of a notification to a meeting organizer, according to an example embodiment.

FIG. 10 is a block diagram of various system entities related to the techniques presented herein, according to an example embodiment.

### DESCRIPTION OF EXAMPLE EMBODIMENTS

The following description is made in connection with an example in which a cross-functional team meets briefly near the beginning of each week. The schedules of attendees/participants of a given meting often differ from one another due to unrelated commitments within their individual functional areas. In addition, each attendee's own schedule may vary from one week to the next as the result of non-recurring meetings, changes to existing meetings, holidays, planned vacation, or other conflicts.

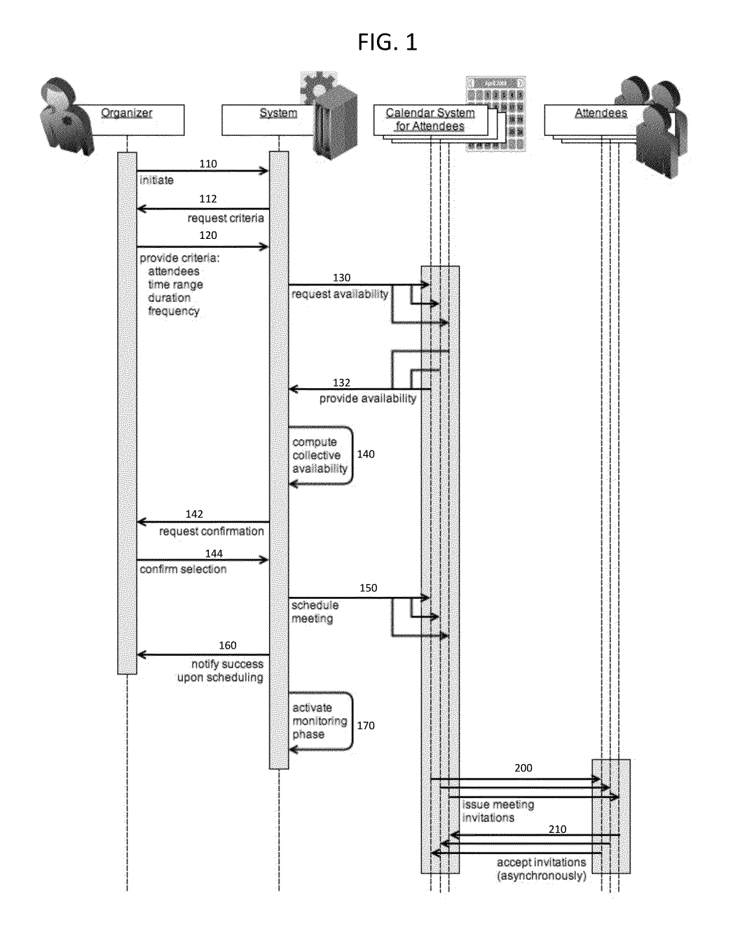

Reference is first made to FIG. 1. FIG. 1 is a system activation and process overview. It outlines the initial direct and indirect interactions of the system with concerned parties. These interactions begin when the organizer attempts to create a new meeting and end when the system enters its “monitoring phase.”

The flow is as follows. At reference numeral 110, the meeting organizer contacts the system an attempts to create a new meeting. At 112, the system requests the criteria for the meeting.

At 120, the organizer inputs to the system all desired meeting characteristics (criteria), such as:
(a) List of attendees (one or more; optional or required)
(b) Time range (fixed or flexible)
(c) Duration (fixed or flexible)
(d) Frequency (recurring or one-time)

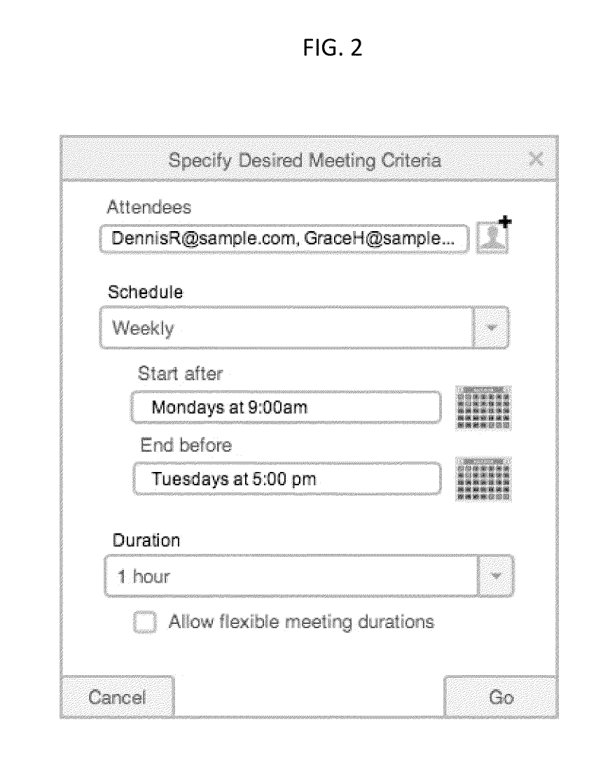

An example of a user interface screen presented to the meeting organizer by the system, at step 120, to prompt the organizer to enter the meeting criteria is shown in FIG. 2. In the example of FIG. 2, the organizer uses this interface to specify a list of attendees (Dennis, Grace, James, and Larry), recurrence schedule (weekly on Mondays or Tuesdays), and duration (exactly 1 hour).

Referring back to FIG. 1, at 130, the system inspects the availability of each attendee through one or more of the following means:
(a) Access attendee-published availability data
(b) Retrieve attendee schedules
(c) Retrieve business operation schedules
(d) Compute availability data from other relevant information accessible to the system

At 132, the calendar system for the attendees responds with the availability of the attendees to the system.

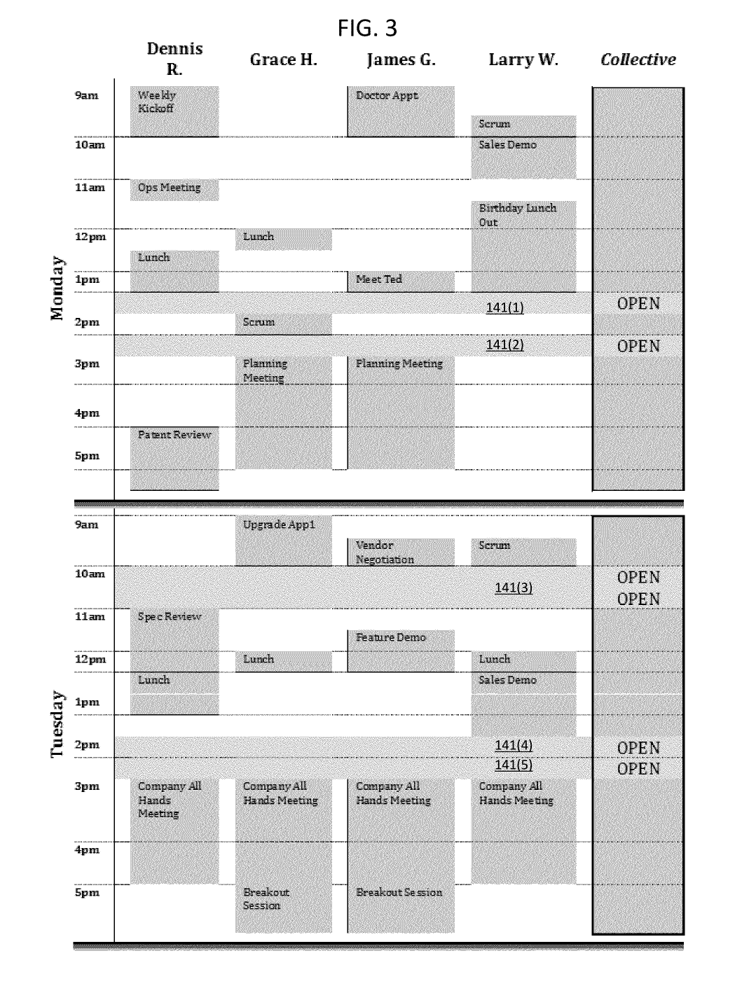

At 140, the system computes the collective availability of the attendees. FIG. 3 illustrates a sample collective availability computation for a given week, e.g., Week 1. Individual schedules (with existing meetings/commitments/busy times) are retrieved for each attendee for the upcoming time range. The collectively open slots are designated as “OPEN” in the far right column, and shown at reference numerals 141(1)-141(5) in the graphical representation of FIG. 3.

The system computes collective availability by narrowing the results of the availability obtained at 132 with the constraints imposed by the information received at 120. This sub-process is referred to as “Automated Meeting Negotiation”. Attendees are omitted from the collective availability computation if their availability data are unavailable.

At 142, the system sends a request to the meeting organizer to confirm the system computations and select an available time slot. Thus, at 142, the system reports the results of the automated meeting negotiation to the organizer. Results may take on one of the following forms
(a) Collective availability cannot conform to desired meeting characteristics (criteria too restrictive);
(b) A single option represents the best match between collective availability and desired meeting characteristics; and
(c) Multiple options are equally well suited to satisfy the specified criteria with the collective availability.

Items (a) and (c) may contain exact matches (all criteria fully satisfied) or approximate matches (optional or flexible criteria partially satisfied). Approximate matches are marked as such in the report given to the organizer.

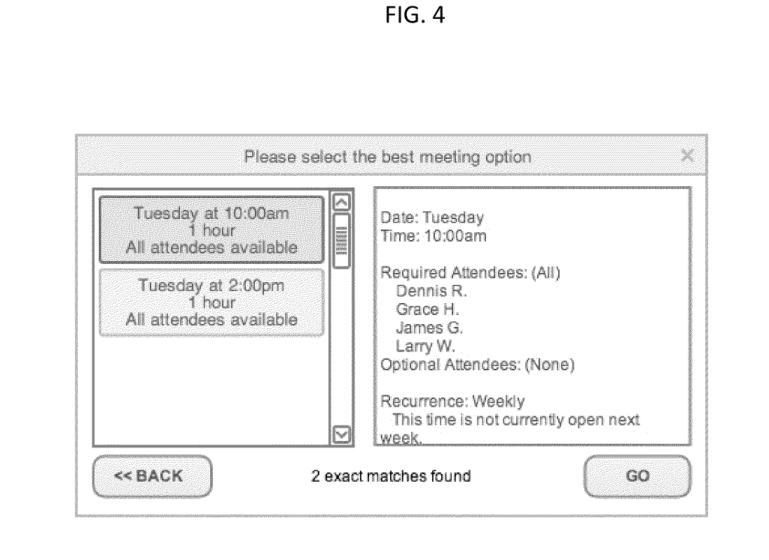

At 144, the organizer confirms his/her selection to the system. FIG. 4 illustrates a sample user interface outline to confirm system computations. The system responds to the organizer, at 142, indicating that there are two open times available that satisfy all the provided criteria. At 144, the organizer can select an option to see its details and then confirm the most appropriate choice. In the situation in which the criteria are not too restrictive, the organizer will confirm the selection and allow the system to continue. Alternatively, the process is cancelled and may be reattempted by returning to step 120.

When the system receives the selection made by the meeting organizer at 144, at 150, the system schedules the meeting according to that selection, and notifies the calendar system for the attendees. Thus, at 150, the system will respond by issuing an invitation for the future meeting to each user through their corresponding electronic calendar.

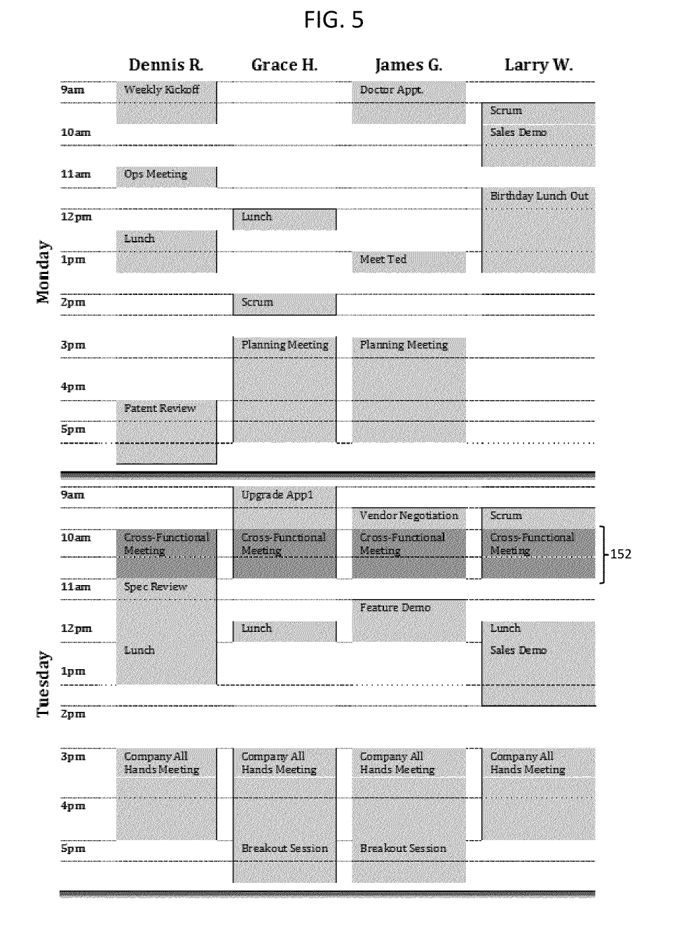

FIG. 5 illustrates an updated sample collective schedule for Week 1. After choosing Tuesday at 10:00 am, the meeting is added to each attendee's calendar, as shown at reference numeral 152.

At 160, the system notifies the meeting organizer that the meeting has been successfully scheduled. The notification may contain additional details not relevant to the individual attendees.

At 170, the system activates a monitoring phase. Adhering to any frequency rules specified in step 120, the system monitors and re-computes collective availability, repeating steps 130, 132 and 150 as needed. This sub-process is referred to as “Dynamic Scheduling”. The dynamic nature of this sub-process allows for differing computed results upon each iteration, thus flexibly adapting to the ever-changing collective availability for the group of attendees.

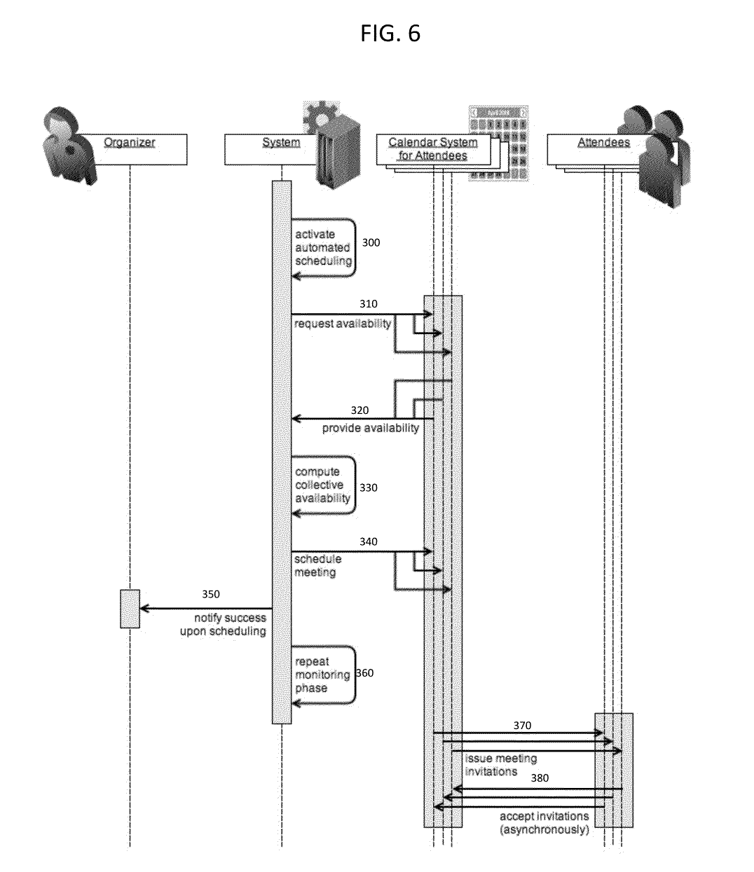

The monitoring phase 170 is described hereinafter in connection with FIG. 6. At some point in time later, at 200, the calendar system will issue meeting invitations to the attendees and the attendees will asynchronously send acceptance to the invitations at 210, assuming they accept.

FIG. 6 is a system monitoring overview. Since the meeting that the meeting organizer scheduled (as depicted in FIGS. 1-6) is a recurring meeting, the system monitors collective availability for upcoming time ranges and repeats (as needed) many of the steps involved in the initial meeting scheduling. At 300, the system activates automated scheduling. At 310, the system requests availability for the attendees of the meeting from the calendar system for the attendees. Collective availability is retrieved for each attendee in the subsequent time range during which the next occurrence of the meeting is to happen. At 320, the system receives the availability information from the calendar system for the attendees. At 330, the system computes collective availability for the next week of the meeting, Week 2.

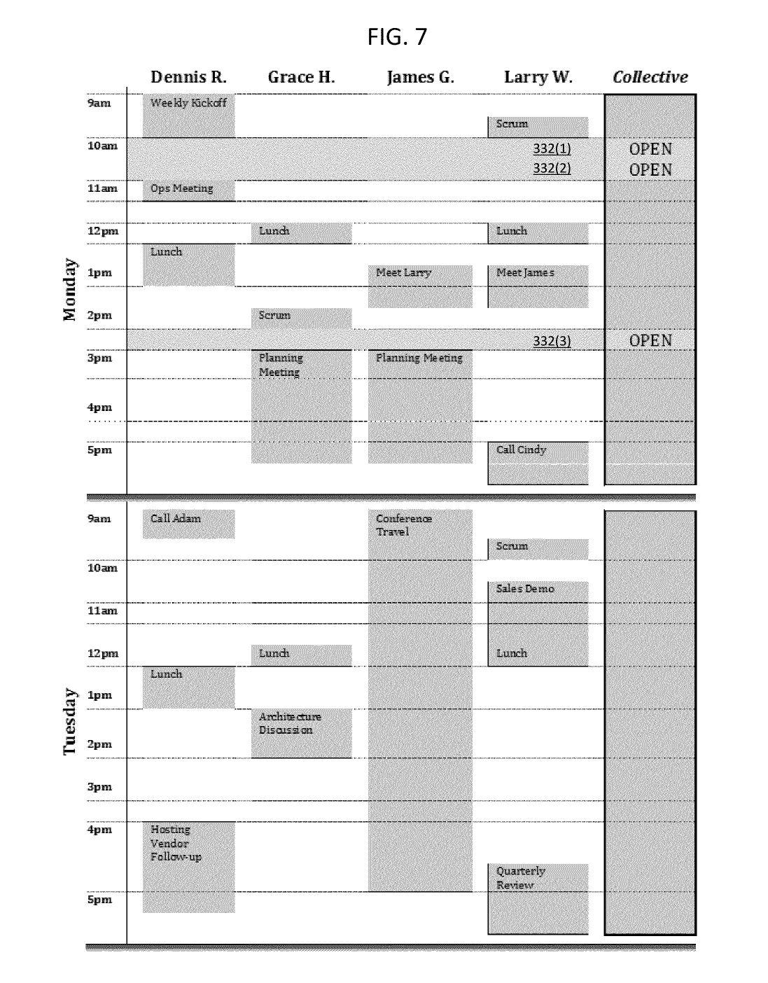

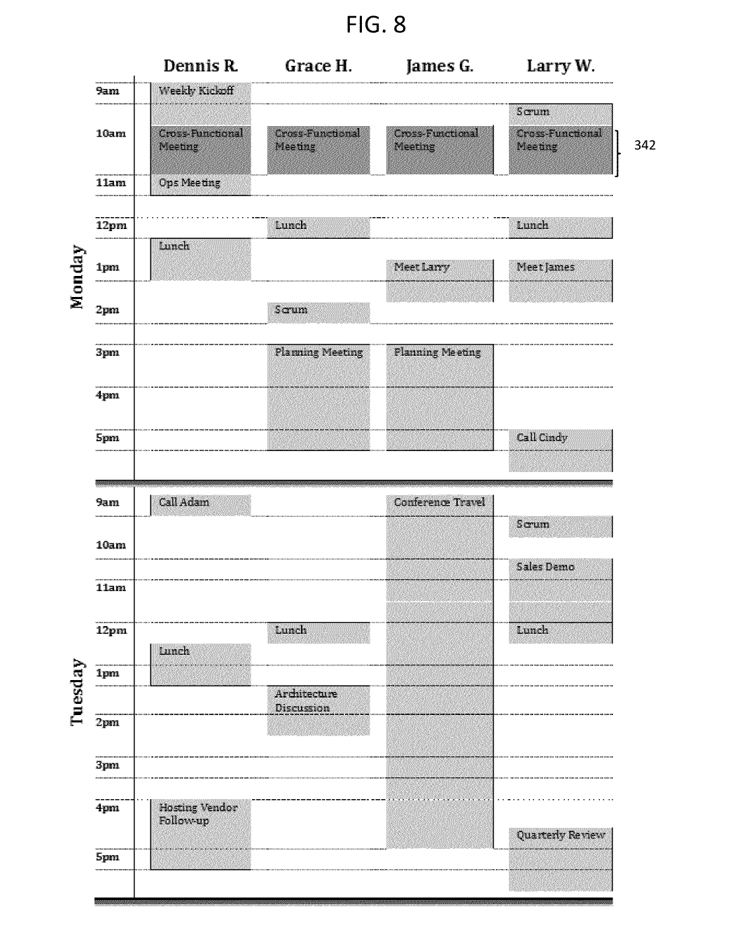

FIG. 7 illustrates a sample collective availability computation for Week 2. Schedules differ per attendee from the previous week, so different times are collectively open, as shown at reference numerals 332(1)-332(3). FIG. 8 illustrates an updated sample collective schedule for Week 2. The system selects the best match (without prompting the organizer) and schedules the meeting at 340, updating each attendee's calendar accordingly. In this example, during Week 2, the time slot of 10 AM on Monday is a better time slot as shown at reference numeral 342, whereas during Week 1, the time slot of 10 AM on Tuesday was used.

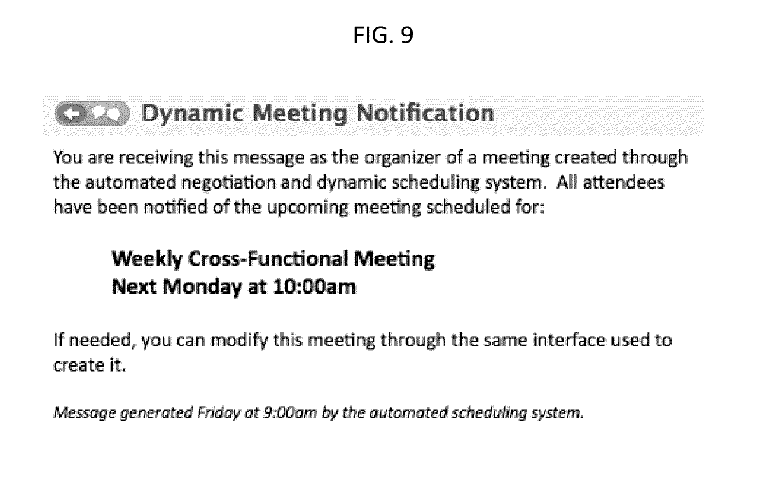

At 350, the system notifies the meeting organizer of the success upon scheduling the meeting for the Week 2. FIG. 9 illustrates a sample notification for a meeting organizer. The organizer receives a notification with details on the automatically scheduled meeting. No action is required, but the organizer has the option to modify the meeting (through “traditional” interactions with the attendee's calendar systems) if need be.

Step 360 indicates the repeat of the monitoring phase in order to schedule the next occurrence of the meeting. Meeting invitations are sent at 370 and acceptances are received at 380.

In summary, the system and method described herein dynamically schedules meetings that satisfy (as best as possible) all specified parameters after inspecting the availability of every attendee. Moreover, when the meeting is a recurring meeting, the system automatically schedules subsequent occurrences of the meeting based on dynamic monitoring of participant availability during the time window for each subsequent meeting occurrence.

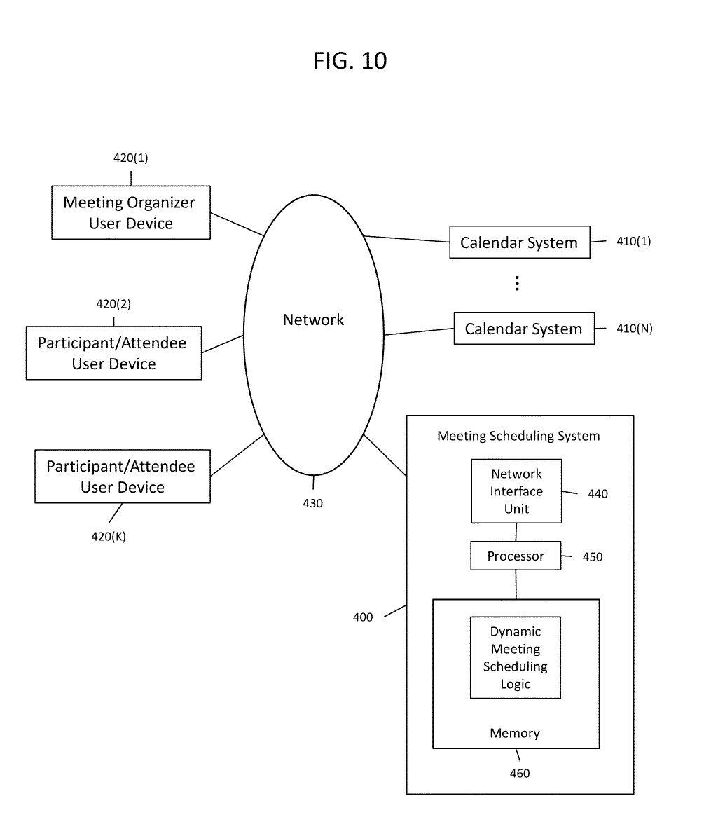

Reference is now made to FIG. 10. FIG. 10 illustrates a block diagram of a system in which the techniques presented herein may be deployed. FIG. 10 shows a meeting scheduling system 400, one or more calendar systems 410(1)-410(N) and a plurality of user devices 420(1)-420(K), where user device 420(1) is arbitrarily denoted a user device of a meeting organizer and user devices 420(2)-420(K) are user devices for participants/attendees. These components communicate with each other by way of network 430. The network 430 may be any combination of a wired or wireless local area network, and wired or wireless wide area network. The user devices 420(1)-420(K) may be hand-held devices, such as Smartphones, laptop computers, desktop computers, thin-client devices, tablets, etc.

The meeting scheduling system 400 includes a network interface unit 440, a processor (or multiple processors) 450 and memory 460. The memory 460 stores executable software instructions for dynamic meeting scheduling logic 470 that, when executed by the processor 450, cause the processor 450 to perform the operations described herein on behalf of the meeting schedule system 400.

The memory 460 may include read only memory (ROM), random access memory (RAM), magnetic disk storage media devices, optical storage media devices, flash memory devices, electrical, optical, or other physical/tangible memory storage devices. In general, the memory 460 may comprise one or more tangible (non-transitory) computer readable storage media (e.g., a memory device) encoded with software comprising computer executable instructions and when the software is executed (by one or more processors) it is operable to perform the operations described herein.

To summarize, in one form, a computer-implemented method is provided comprising: receiving at a meeting scheduling system a criteria for a meeting to be scheduled, the criteria including a plurality of participants, time range, meeting duration and meeting frequency; obtaining availability information of the participants from at least one calendar system used by the plurality of participants; computing collective availability for the meeting based on the availability information; sending a notification of the collective availability for the meeting to a meeting organizer; receiving a selection of a time slot for a first occurrence of the meeting from the meeting organizer; scheduling the first occurrence of the meeting with the at least one calendar system; automatically monitoring availability of the plurality of participants for a subsequent occurrence of the meeting by obtaining availability of the plurality of participants from the at least one calendar system; computing collective availability of the plurality of participants during a time range desired for the subsequent occurrence of the meeting; automatically selecting a time slot for the subsequent occurrence of the meeting based on the collective availability computed during the time range desired for the subsequent occurrence of the meeting; and scheduling the subsequent occurrence of the meeting with the at least one calendar system.

In another form, an apparatus is provided comprising a network interface unit configured to enable network communications; and a processor coupled to the network interface unit, wherein the processor is configured to: receive a criteria for a meeting to be scheduled, the criteria including a plurality of participants, time range, meeting duration and meeting frequency; obtain availability information of the participants from at least one calendar system used by the plurality of participants; compute collective availability for the meeting based on the availability information; cause a notification of the collective availability for the meeting to be sent to a meeting organizer; receive a selection of a time slot for a first occurrence of the meeting from the meeting organizer; schedule the first occurrence of the meeting with the at least one calendar system; automatically monitor availability of the plurality of participants for a subsequent occurrence of the meeting by obtaining availability of the plurality of participants from the at least one calendar system; compute collective availability of the plurality of participants during a time range desired for the subsequent occurrence of the meeting; automatically select a time slot for the subsequent occurrence of the meeting based on the collective availability computed during the time range desired for the subsequent occurrence of the meeting; and schedule the subsequent occurrence of the meeting with the at least one calendar system.

In yet another form, one or more non-transitory computer readable storage media encoded with instructions that, when executed by a processor, cause the processor to: receive a criteria for a meeting to be scheduled, the criteria including a plurality of participants, time range, meeting duration and meeting frequency; obtain availability information of the participants from at least one calendar system used by the plurality of participants; compute collective availability for the meeting based on the availability information; cause a notification of the collective availability for the meeting to be sent to a meeting organizer; receive a selection of a time slot for a first occurrence of the meeting from the meeting organizer; schedule the first occurrence of the meeting with the at least one calendar system; automatically monitor availability of the plurality of participants for a subsequent occurrence of the meeting by obtaining availability of the plurality of participants from the at least one calendar system; compute collective availability of the plurality of participants during a time range desired for the subsequent occurrence of the meeting; automatically select a time slot for the subsequent occurrence of the meeting based on the collective availability computed during the time range desired for the subsequent occurrence of the meeting; and schedule the subsequent occurrence of the meeting with the at least one calendar system.

The above description is intended by way of example only. Although the techniques are illustrated and described herein as embodied in one or more specific examples, it is nevertheless not intended to be limited to the details shown, since various modifications and structural changes may be made within the scope and range of equivalents of the claims.

What is claimed is:

1. A computer-implemented method comprising:
receiving at a meeting scheduling system a criteria for a meeting to be scheduled, the criteria including a plurality of participants, time range, meeting duration and meeting frequency;
obtaining availability information of the participants from at least one calendar system used by the plurality of participants;
computing collective availability for the meeting based on the availability information;
sending a notification of the collective availability for the meeting to a meeting organizer;
receiving a selection of a time slot for a first occurrence of the meeting from the meeting organizer;
scheduling the first occurrence of the meeting with the at least one calendar system;
automatically monitoring availability of the plurality of participants for a subsequent occurrence of the meeting by obtaining availability of the plurality of participants from the at least one calendar system;
computing collective availability of the plurality of participants during a time range desired for the subsequent occurrence of the meeting;
automatically selecting a time slot for the subsequent occurrence of the meeting based on the collective availability computed during the time range desired for the subsequent occurrence of the meeting; and
scheduling the subsequent occurrence of the meeting with the at least one calendar system.

2. The method of claim 1, further comprising sending a notification of success to the meeting organizer upon scheduling the subsequent occurrence of the meeting.

3. The method of claim 1, wherein for each of additional subsequent occurrences of the meeting in future time ranges, performing the automatically monitoring, the computing collective availability, the automatically selecting and the scheduling the subsequent occurrence of the meeting.

4. The method of claim 1, further comprising the at least one calendar system sending a meeting invitation for each occurrence of the meeting to each participant, and receiving an acceptance from each participant.

5. An apparatus comprising:
a network interface unit configured to enable network communications; and
a processor coupled to the network interface unit, wherein the processor is configured to:
receive a criteria for a meeting to be scheduled, the criteria including a plurality of participants, time range, meeting duration and meeting frequency;
obtain availability information of the participants from at least one calendar system used by the plurality of participants;
compute collective availability for the meeting based on the availability information;
cause a notification of the collective availability for the meeting to be sent to a meeting organizer;
receive a selection of a time slot for a first occurrence of the meeting from the meeting organizer;
schedule the first occurrence of the meeting with the at least one calendar system;
automatically monitor availability of the plurality of participants for a subsequent occurrence of the meeting by obtaining availability of the plurality of participants from the at least one calendar system;
compute collective availability of the plurality of participants during a time range desired for the subsequent occurrence of the meeting;
automatically select a time slot for the subsequent occurrence of the meeting based on the collective availability computed during the time range desired for the subsequent occurrence of the meeting; and
schedule the subsequent occurrence of the meeting with the at least one calendar system.

6. The apparatus of claim 5, wherein the processor is further configured to cause a notification of success to be sent to the meeting organizer upon scheduling the subsequent occurrence of the meeting.

7. The apparatus of claim 5, wherein for each of additional subsequent occurrences of the meeting in future time ranges, the processor is configured to perform the automatically monitor, compute collective availability, automatically select and schedule of the subsequent occurrence of the meeting.

8. A system comprising the at least one calendar system and the apparatus of claim 5, and wherein the at least one calendar system sends a meeting invitation for each occurrence of the meeting to each participant, and receive an acceptance from each participant.

9. One or more non-transitory computer readable storage media encoded with instructions that, when executed by a processor, cause the processor to:
receive a criteria for a meeting to be scheduled, the criteria including a plurality of participants, time range, meeting duration and meeting frequency;
obtain availability information of the participants from at least one calendar system used by the plurality of participants;
compute collective availability for the meeting based on the availability information;
cause a notification of the collective availability for the meeting to be sent to a meeting organizer;
receive a selection of a time slot for a first occurrence of the meeting from the meeting organizer;
schedule the first occurrence of the meeting with the at least one calendar system;
automatically monitor availability of the plurality of participants for a subsequent occurrence of the meeting by obtaining availability of the plurality of participants from the at least one calendar system;
compute collective availability of the plurality of participants during a time range desired for the subsequent occurrence of the meeting;
automatically select a time slot for the subsequent occurrence of the meeting based on the collective availability computed during the time range desired for the subsequent occurrence of the meeting; and
schedule the subsequent occurrence of the meeting with the at least one calendar system.

10. The non-transitory computer readable storage media of claim 9, further comprising instructions that cause the processor to send a notification of success to the meeting organizer upon scheduling the subsequent occurrence of the meeting.

11. The non-transitory computer readable storage media of claim 9, further comprising instructions that cause the processor, for each of additional subsequent occurrences of the meeting in future time ranges, perform the automatically monitor, the compute collective availability, the automatically select and the schedule the subsequent occurrence of the meeting.
